(19) United States
(12) Patent Application Publication
(10) Pub. No.: US 2025/0328492 A1
(43) Pub. Date: Oct. 23, 2025

(54) SNAPSHOT CONSOLIDATION

(71) Applicant: Rubrik, Inc., Palo Alto, CA (US)

(72) Inventors: Vaiapuri Ramasubramaniam, Bengaluru (IN); Chaitanya Nettem, Bengaluru (IN); Sarat Kallepalli, Bengaluru (IN)

(21) Appl. No.: 18/642,592

(22) Filed: Apr. 22, 2024

(51) Int. Cl. G06F 16/11

(52) U.S. Cl. CPC G06F 16/125; G06F 16/128

(57) ABSTRACT

Methods, systems, and devices for data management are described. A first snapshot file associated with a first point-in-time may be identified as expired. The first snapshot file may be partitioned into a first set of data portions stored at a first set of storage locations. Also, a second snapshot file associated with a second point-in-time may be partitioned into a second set of data portions stored at a second set of storage locations. Based on the first snapshot file being expired, a third snapshot file associated with the second point-in-time may be generated from the first snapshot file and the second snapshot file. The third snapshot file may be partitioned into a third set of data portions, where data portions of the third data portions may be stored at storage locations of the first set of storage locations and the second set of storage locations.

### FIELD OF TECHNOLOGY

The present disclosure relates generally to data management, including techniques for snapshot consolidation.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports snapshot consolidation in accordance with aspects of the present disclosure.

FIG. 2 shows an example of a subsystem that supports snapshot consolidation in accordance with aspects of the present disclosure.

FIG. 3 shows an example of a set of operations for snapshot consolidation in accordance with aspects of the present disclosure.

FIG. 4 shows an example of a diagram for snapshot consolidation in accordance with aspects of the present disclosure.

FIG. 5 shows a block diagram of an apparatus that supports snapshot consolidation in accordance with aspects of the present disclosure.

FIG. 6 shows a block diagram of a data manager that supports snapshot consolidation in accordance with aspects of the present disclosure.

FIG. 7 shows a diagram of a system including a device that supports snapshot consolidation in accordance with aspects of the present disclosure.

FIG. 8 shows a flowchart illustrating methods that support snapshot consolidation in accordance with aspects of the present disclosure.

### DETAILED DESCRIPTION

A data management system (DMS) may store full and incremental snapshots for a computing object, where the full and incremental snapshots may build on one another to form a snapshot chain. The full and incremental snapshots may be stored in the DMS as snapshot files (e.g., individual files) that use file formats supported by a file system of the DMS. The snapshot files may be structured to include first data portions (which may be referred to as “data blocks”) and second, larger data portions (which may be referred to as “stripes”) that include respective sets of data blocks. When an incremental snapshot file (or multiple incremental snapshot files) is removed from the snapshot chain, data from the removed incremental snapshot file (or multiple incremental snapshot files) may be consolidated with a subsequent incremental snapshot file (or multiple subsequent snapshot files)—e.g., to preserve the integrity of the snapshot chain. In some examples, the consolidation occurs at a data block level and involves copying the data blocks for the subsequent incremental snapshot file and a subset of the data blocks for the removed incremental snapshot file (e.g., that are omitted for the subsequent incremental snapshot file) to new storage locations at the DMS associated with a replacement snapshot file generated to represent the subsequent incremental snapshot file in place of the original snapshot file generated for the subsequent incremental snapshot file.

A consolidation operation that transfers data of snapshot files to be consolidated from prior storage locations to new storage locations (which may be referred to as a “copy consolidation” procedure) may consume an excessive quantity of disk input/output (I/O) cycles, may consume an excess quantity of processing resources, may be more prone to storage corruption (e.g., due to the excessive quantity of write operations), may excessively contribute to disk fragmentation (e.g., due to transferring each data block to a new storage location), or any combination thereof. Thus, implementations that support consolidating snapshot files more efficiently may be desired.

To consolidate snapshot files more efficiently, data portions of one or more expired snapshot files and one or more subsequent snapshot files may be reused at a stripe level to generate one or more replacement snapshot files—e.g., during a “reuse consolidation” procedure. In some examples, a determination of whether to perform a reuse consolidation procedure or a copy consolidation procedure may be made based on one or more criteria—e.g., how many data blocks in a stripe can be reused, a sequentially of the data blocks in a potential replacement snapshot file, etc.

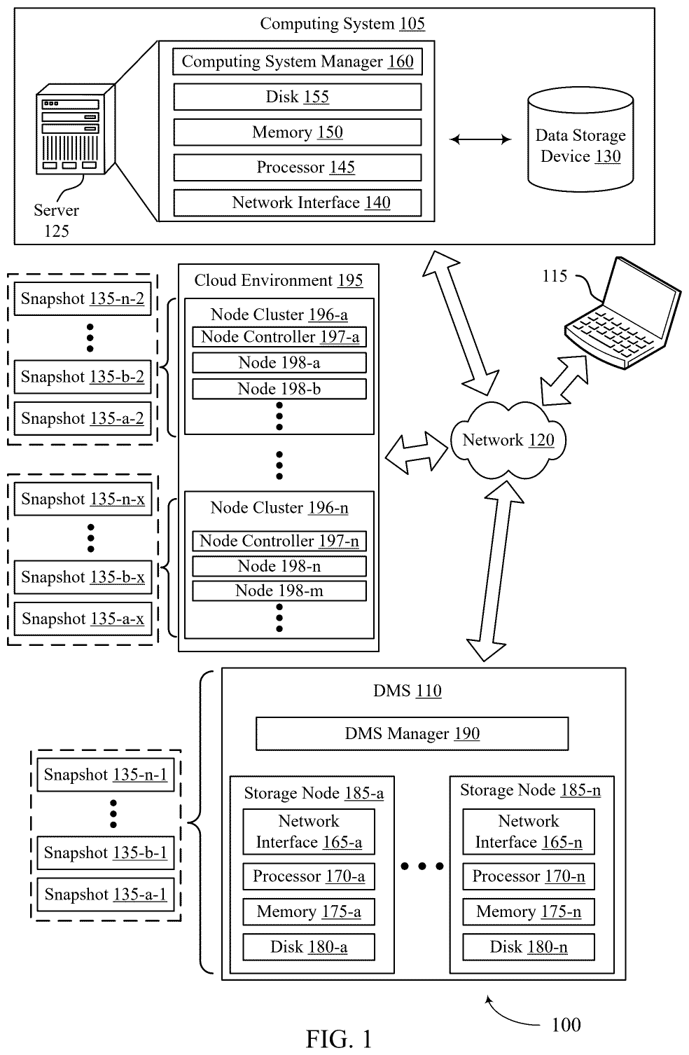

FIG. 1 illustrates an example of a computing environment 100 that supports snapshot consolidation in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system, in whole or in part) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

As described herein, a DMS may capture and store states of a computing object (e.g., one or more aspects of computing system 105, including potentially computing system 105 in its entirety or any portion thereof) at multiple points-in-time (which may be referred to as “snapshots” of the computing object). In some examples, a state of a computing object may include the state of data at the computing object, the state of configuration of the computing object, and the like. The DMS may take full snapshots, where a full snapshot may capture a state of all the data of the computing object. The DMS may also take incremental snapshots, where an incremental snapshot may capture a state of a portion of the data of the computing object—e.g., the portions of data that have changed relative to preceding full snapshots, preceding incremental snapshots, or a combination thereof. Together with a full snapshot, an incremental snapshot may be used to restore all the data of the computing object to a point-in-time corresponding to a time when the incremental snapshot of the computing object was captured.

In some examples, after obtaining a full snapshot of a computing object, the subsequent snapshots (e.g., all of the subsequent snapshots) taken of the computing object may be incremental snapshots, where each incremental snapshot may be captured relative to a preceding incremental snapshot. That is, each snapshot in a chain of snapshots may build on one another to form a “snapshot chain,” where each incremental snapshot may capture changes to the data of the computing object at particular points-in-time relative to the preceding snapshot taken at a preceding point-in-time, where the preceding snapshot may be a full snapshot (e.g., for the second snapshot in the snapshot chain), an incremental snapshot (e.g., for the third snapshot in the snapshot chain, for the fourth snapshot in the snapshot chain, and so on).

The DMS may preserve one or more snapshots of a computing object by storing one or more corresponding snapshot files. The storage of the snapshot files may be managed (e.g., tracked, organized, searched, queried etc.) using a software-defined file system (SDFS). In some examples, each snapshot may be stored in its own snapshot file. The one or more snapshot files may be created in accordance with one or more file formats supported by the SDFS. In some examples, snapshot files for a computing object are generated, and stored, in accordance with one or more file formats that are best-suited for the computing object. For example, for a particular computing object, a patchfile format may be preferred, and each snapshot file for the computing object may be generated and stored in accordance with a respective patchfile. In some examples, the SDFS may be used to keep track of how and where snapshot files are stored in the DMS. The SDFS may further be used to generate and store information about (e.g., metadata for) the snapshot files, the corresponding snapshots, or both. For example, the SDFS may store metadata, such as a creation date, an expiration date, a position of the corresponding snapshot in a chain of snapshots, storage locations in the DMS for the data of the snapshot files, whether the snapshot is protected from deletion, a user-generated name or description of the snapshot, etc.

In some examples, each snapshot file (e.g., which may use a patchfile format) in the SDFS is used to store first data portions (e.g., data blocks), which may include a similar, or a same, amount of uncompressed data (e.g., 64 KiB). Each data block may be associated with a block number in a logical space—e.g., a first block assigned block number 0 may be located at offset 0 of a logical space and be 64 KiB in size (before compression), a second block assigned block number 1 may be located at offset 1 (e.g., 64 KiB from a beginning of the first block) of the logical space and be 64 KiB in size (before compression), and so on. In some examples, a size of the data blocks may differ from one another after being packaged for storage on disk—e.g., due to differences in compression ratios achievable for the different data blocks, particular storage techniques used to store data, or both.

The data blocks, after being processed (e.g., compressed, encrypted, fingerprinted, and/or error managed) for storage, may be packaged into second data portions (e.g., which may be referred to as “stripes”). Each stripe may support storage of a threshold amount of data (e.g., 128 MiB). For example, if 128 MiB stripes are used, a snapshot file that includes 1 GiB of processed (e.g., compressed, encrypted, fingerprinted, and/or error managed) data may be split across eight stripes. In some examples, the snapshot file including the 1 GiB or processed data is split across a ninth stripe to support the storage of metadata. In some examples, a stripe may support the storage of more data blocks than is derived by dividing a size of the stripe by a size of individual data blocks. For example, if 128 MiB stripes are used and individual data block are 64 KiB in size, a stripe may support the storage of more than 2048 processed data blocks (e.g., due to compression of the data blocks). In some examples, one or more of the stripes (e.g., the last stripe, the last two stripes) may store metadata related to the snapshot file (e.g., a creation date) and, in some examples, the corresponding snapshot (e.g., a user-generated name of the snapshot). In some examples, a stripe that stores metadata may also store data blocks. In some examples, a snapshot file may be split across stripes that differ in size—e.g., the last stripe may be smaller than the preceding stripes of the snapshot file. In some examples, a processed data block may be stored across multiple stripes—e.g., a processed data block may extend from an end of one stripe to a beginning of a next stripe.

The DMS may store the data of a snapshot file to disk at a stripe-level. In some examples, the DMS may store the data of a snapshot file to multiple nodes of the DMS at the stripe-level. In some examples, the DMS may partition a stripe into third data portions (e.g., which may be referred to as “chunks”) and store the third data portions across multiple nodes of the DMS. In some examples, each chunk is 32 MiB in size. In some examples, as part of storing the data to the nodes, the DMS may also compute parity information for the stripes that is stored in the nodes along with the stripes and may be used to recover data if a stripe is corrupted—e.g., if data in up two of the chunks is corrupted.

In some examples, the DMS may capture snapshots for a computing object (e.g., in accordance with a service level agreement with a customer). For example, the DMS may capture five snapshots (e.g., S1, S2, S3, S4, and S5) for a computing object in accordance with a schedule, based on the occurrence of an event, or both. The first snapshot (S1) may be a full snapshot and may capture all data blocks of the computing object at the time the first snapshot (S1) is taken. The remaining snapshots (S2 through S5) may be incremental snapshots. The second snapshot (S2) may be an incremental snapshot and may capture the data blocks of the computing object that have changed since the first snapshot was taken. The third snapshot (S3) may be an incremental snapshot and may capture the data blocks of the computing object that have changed since the second snapshot (S2) was taken, and so on. Thus, the snapshots may build on one another to form the snapshot chain (S1←S2←S3←S4←S5).

The DMS may store the snapshots as snapshot files to disk (e.g., which may be distributed across multiple nodes of the DMS)—e.g., as described herein. In some examples, the snapshot files may be generated and stored in accordance with a patchfile format and may be represented as (P1←P2←P3←P4←P5).

Throughout operation, the DMS may delete one or more snapshot files taken for a computing object (e.g., in accordance with a service level agreement with a customer). For example, the DMS may delete snapshot files corresponding to snapshots that are of a certain age (were taken a threshold duration ago), snapshots that are of a certain age within one or more time frames, and the like. Such snapshots may be referred to as expired snapshots. In some examples, the DMS may wait to delete snapshot files for expired snapshots until after a threshold quantity of snapshots have been taken for the computing object. In some examples, the DMS may delete multiple snapshot files corresponding to multiple expired snapshots during a single expiration operation.

As described above, since a set of snapshots (e.g., S1 through S5) may build on one another to form a snapshot chain, deleting one or more snapshot files corresponding to one or more snapshots (e.g., removing one or more “links” in the snapshot chain) may require the snapshot chain to be repaired as (and/or, in some examples, after) the one or more snapshot files are deleted. For example, to maintain the integrity of the snapshot chain, data stored in a snapshot file corresponding to an expired snapshot (e.g., S2) that is deleted may be consolidated with the data of a snapshot file corresponding to a subsequent snapshot (e.g., S3). In some examples, a portion of the data (e.g., data blocks that were modified when S2 was taken relative to when S1 was taken but not modified when S3 was taken relative to when S2 was taken) stored in the snapshot file being deleted may be consolidated with the snapshot file for the subsequent snapshot to form a modified version of the snapshot file for the subsequent snapshot. After the snapshot file for the expired snapshot and the snapshot file for the subsequent snapshot are consolidated, the snapshot chain may be updated to be S1←S3←S4←S5.

For example, data and metadata for an expired snapshot (e.g., S2) may be stored, using a patchfile format, in an “expired” snapshot file (e.g., which may be referred to as P2) that is separated into a first stripe (e.g., Stripe 2.0), a second stripe (e.g., Stripe 2.1), and a third stripe (e.g., Stripe 2.2). Stripe 2.0 may include data blocks 1, 2, 5, and 6; Stripe 2.1 may include data blocks 21, 39, and 56; and Stripe 2.2 may include data block 62 and metadata for the expired snapshot file and, in some examples, the expired snapshot (e.g., S2). The stripes of the expired snapshot may be stored at first storage locations of the DMS.

Also, data and metadata for a subsequent snapshot (e.g., S3) may be stored, using a patchfile format, in a “subsequent” snapshot file (e.g., which may be referred to as P3) that is separated into a first stripe (e.g., Stripe 3.0), a second stripe (e.g., Stripe 3.1), and a third stripe (e.g., Stripe 3.2). Stripe 3.0 may include data blocks 9, 11, 16, and 17; Stripe 3.1 may include data blocks 20, 39, and 72; and Stripe 3.2 may include data block 75 and metadata for the subsequent snapshot file and, in some examples, the subsequent snapshot (e.g., S3). The stripes of the subsequent snapshot may be stored at second storage locations of the DMS.

In such cases, to maintain the snapshot chain when the expired snapshot file (e.g., P2) is deleted, the DMS may generate, using the patchfile format, a “replacement” snapshot file (e.g., which may be referred to as P3′) that enables the subsequent snapshot of the computing object (e.g., S3) to be recovered without the deleted snapshot file (e.g., P2). The replacement snapshot file may be separated into a first stripe (e.g., Stripe 3′.0), a second stripe (e.g., Stripe 3′.1), a third stripe (e.g., Stripe 3′.2), a fourth stripe (e.g., Stripe 3′.3), and a fifth stripe (e.g., Stripe 3′.4). Stripe 3′.0 may include data blocks 1, 2, 5, 6 (from the expired snapshot file); Stripe 3′.1 may include data blocks 9, 11, 16, and 17 (from the subsequent snapshot file); Stripe 3′.2 may include data blocks 20 (from the subsequent snapshot file), 21 (from the expired snapshot file), and 39 (from the subsequent snapshot file); Stripe 3′.3 may include data blocks 56 (from the expired snapshot file), 62 (from the expired snapshot file), and 72 (from the subsequent snapshot file); and Stripe 3′.4 may include data block 75 (from the subsequent snapshot file) and metadata for the replacement snapshot file and, in some examples, the subsequent snapshot (e.g., S3). In some examples, the metadata in Stripe 3′.4 is based at least in part on the metadata of S2 and the metadata of S3. The stripes of the replacement snapshot file may be stored at third storage locations of the DMS.

To consolidate one or more snapshot files, the DMS may first identify data blocks in the expired snapshot file (e.g., P2) that are overwritten by the subsequent snapshot file (e.g., P3)—e.g., data blocks that are in both the expired and subsequent snapshot files, such as data block 39 which is in both P2 and P3, where the version of data block 39 in P3 overwrites the version of data block 39 in P2. The DMS may then create the replacement snapshot file (e.g., P3′), which may include all the data blocks from the subsequent snapshot file (e.g., P3) and the data blocks in the expired snapshot file (e.g., P2) that are not overwritten by the subsequent snapshot file (which may be none, a subset, or all of the data blocks in the expired snapshot file).

As part of creating the replacement snapshot file (e.g., P3′), the DMS may read, from the second storage locations, all the data blocks from the subsequent snapshot file (e.g., P3) and may read, from at least a subset of the first storage locations, all the data blocks from the expired snapshot file (e.g., P2) that are not also included in (e.g., not overwritten in) the subsequent snapshot file. Based on reading these data blocks, the DMS may write, to the third storage locations, these data blocks into the replacement snapshot file (e.g., P3′)—e.g., in logical offset (and block number) increasing order. In some examples, the DMS may also generate metadata for the replacement snapshot file and may write the metadata to the third storage locations. Storing the data blocks in an increasing order, particularly within a stripe, may improve an efficiency of subsequent read operations of the replacement snapshot file—e.g., by enabling sequential reading of the replacement snapshot file.

A consolidation operation that transfers data of snapshot files to be consolidated from prior storage locations to new storage locations (which may be referred to as a “copy consolidation” procedure) may consume an excessive quantity of disk input/output (I/O) cycles, may consume an excess quantity of processing resources, may be more prone to storage corruption (e.g., due to the excessive quantity of write operations), may excessively contribute to disk fragmentation (e.g., due to transferring each data block to a new storage location), or any combination thereof. For example, if all of the data blocks in a subsequent snapshot file (e.g., P3) and half of the data blocks in an expired snapshot file (e.g., P2) are to be added to the replacement snapshot file (e.g., P3′), then the consolidation process for creating the replacement snapshot file may (assuming the expired snapshot file and the subsequent snapshot file are similar in size) read around 1.5 times the size of the subsequent snapshot file from disk and write 1.5 times the size of the subsequent snapshot file to disk, consuming a quantity of disk bytes (e.g., disk I/O cycles) that is around three times the size of the subsequent snapshot file. In some examples, the consolidation operation may consume an excessive quantity of processing (e.g., central processing unit (CPU)) cycles during decompression of the data in each data block read from the disk for the expired and subsequent snapshot files, recompression of the data for each data block written to the disk for the replacement snapshot file, recomputation of fingerprints while the replacement snapshot file is written to the disk, recomputation of information for error correction (e.g., parity) of the stripes, or any combination thereof. Thus, implementations (e.g., systems, techniques, methods, operations, apparatuses, mechanisms, devices, instruments, components, configurations) that support consolidating snapshot files more efficiently may be desired.

To consolidate snapshot files more efficiently, data portions of one or more expired snapshot files and one or more subsequent snapshot files may be reused at a stripe level to generate one or more replacement snapshot files—e.g., during a “reuse consolidation” procedure. In some examples, a determination of whether to perform a reuse consolidation procedure or a copy consolidation procedure may be made based on one or more criteria—e.g., how many data blocks in a stripe can be reused, a sequentially of the data blocks in a potential replacement snapshot file, etc.

In some examples, a component at the DMS 110 (e.g., a snapshot management component) may identify that one or more snapshot files of multiple snapshot files associated with the computing object have expired. The multiple snapshot files may be stored at the DMS 110, external to the DMS 110 (e.g., at a cloud storage), or both. In some examples, the multiple snapshot files represent multiple states (e.g., of a file system, of a database, of a folder, of a volume, etc.) of the computing object at respective points-in-time. The multiple snapshot files may include one or more full snapshot files and one or more incremental snapshot files. In some examples, a set of incremental snapshot files may be incremental relative to a corresponding full snapshot file.

A component of the DMS 110 (e.g., a file system component) may partition the snapshot files into respective data portions (which may also be referred to as stripes). The respective data portions may include one or more data blocks and may be stored at respective storage locations associated with (e.g., at or managed by) the DMS 110. For example, a first (e.g., expired) snapshot file representing a first state of the computing object at a first point-in-time may be partitioned into a first set of stripes, which may be stored at a first set of storage locations. Also, a second snapshot file representing a second state of the computing object at a second point-in-time may be partitioned into a second set of stripes stored at a second set of storage locations. In some examples, the first snapshot file and the second snapshot file both include data for restoring the computing object to the second point-in-time. Accordingly, the data for restoring the computing object to the second point-in-time in the first (expired) snapshot file may be preserved prior to deletion of the first snapshot file.

A component of the DMS 110 (e.g., the snapshot management component) may generate a third snapshot file that consolidates the information in the second snapshot file with the information that is included in the first snapshot file for restoring the computing object to the second point-in-time. In some examples, the component generates a third snapshot file that represents the state of the computing object at the second point-in-time based on the first (expired) snapshot file and the second snapshot file. Particularly, the component may generate the third snapshot file to include one or more (e.g., reused) stripes of the first set of stripes of the first snapshot file, one or more (e.g., reused) stripes of the second set of stripes of the second snapshot files and one or more stripes of a third set of stripes generated for the third snapshot file. The one or more stripes of the first set of stripes and the one or more stripes of the second set of stripes may remain stored at the first set of storage locations and the second set of storage locations, respectively. In some examples, the third snapshot file includes the one or more stripes of the first set of stripes and the one or more stripes of the second set of stripes by including references in the third snapshot file (e.g., in metadata of the third snapshot file) to the one or more stripes of the first set of stripes and the one or more stripes of the second set of stripes.

Although described in the context of a single expired snapshot file, similar operations may be used to consolidate an expired snapshot file with multiple nonexpired snapshot files associated with respective points-in-time, multiple expired snapshot files with a snapshot file associated with a particular point-in-time, multiple sets of expired snapshot files with respective snapshot files associated with respective points-in-time, one or more expired snapshot files and one or more nonexpired snapshot files with a snapshot file associated with a particular point-in-time, and the like.

By reusing stripes of a set of snapshot files being consolidated into a replacement snapshot file (e.g., instead of copying the data in the stripes into new stripes for the replacement snapshot file), a processing burden associated with extracting the data from the stripes, uncompressing the data in the stripes, recompressing the data in the stripes, recalculating fingerprints for the data in the stripes, and writing the data in the stripes to new storage locations, among other operations, may be avoided. Additionally, defragmentation of a disk used to store snapshot files may be reduced—e.g., by reducing the amount of data in the storage that is invalidated and rewritten to a new location of storage. By determining whether to perform a reuse consolidation procedure or a copy consolidation procedure to consolidate snapshot files (e.g., based on how many stripes can be reused for a potential replacement snapshot file, a sequentiality of data blocks in the potential replacement snapshot file, etc.), a consolidation technique that balances processing efficiency for consolidating snapshot files into replacement snapshot files with access efficiency for subsequently accessing replacement snapshot files may be selected.

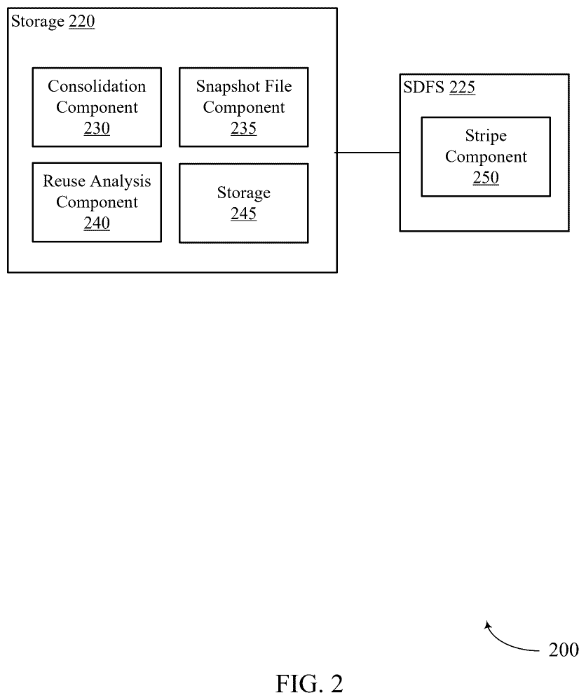

FIG. 2 shows an example of a subsystem that supports snapshot consolidation in accordance with aspects of the present disclosure.

The subsystem 200 may include the storage 220 and the SDFS 225. In some examples, the subsystem 200 is included within a DMS, such as the DMS 110 of FIG. 1.

The storage 220 may be configured to generate and store snapshot files, among other files. In some examples, the storage 220 may include the consolidation component 230, the snapshot file component 235, the reuse analysis component 240, and the storage 245.

The consolidation component 230 may be configured to initiate a procedure for identifying expired snapshot file(s) and consolidating the information in the expired snapshot file(s) with information in snapshots that depend on the expired snapshot files(s) into replacement snapshot file(s).

The snapshot file component 235 may be configured to generate snapshot files—e.g., replacement snapshot files. In some examples, the snapshot file component 235 may be configured to generate snapshot files in accordance with a format supported by the SDFS 225 (e.g., a patchfile format, a two level key-value store format (TLKVS), etc.). The snapshot file component 235 may be further configured to store the snapshot files in the storage 245. In some examples, the snapshot file component 235 is configured to generate replacement snapshot files that include references to stripes of a set of snapshot files being consolidated.

The reuse analysis component 240 may be configured to analyze stripes of snapshot files to be consolidated and to build simulated snapshot file(s) based on the information in the consolidated snapshot files. In some examples, the reuse analysis component 240 may be configured to determine which stripes in the consolidated snapshot files to reuse (e.g., based on whether a quantity of data blocks in the stripe exceeds a threshold) and whether to trigger a reuse consolidation procedure (e.g., based on whether a sequentiality of a simulated snapshot file exceeds a threshold).

The storage 245 may be configured to store the snapshot files generated by the snapshot file component 235. In some examples, a structure of the storage 245 (e.g., volumes, data planes, pages, data blocks, data bytes, etc.) and how the snapshot files are stored in the storage 245 may differ from a structure of the snapshot files (e.g., stripes, data blocks, etc.) generated by the snapshot file component 235.

The SDFS 225 may be configured to provide a file management system for (e.g., in accordance with one or more supported file formats) organizing and managing the storage of snapshots at the storage 220. The SDFS may include the stripe component 250. The stripe component 250 may be configured to keep track of the stripes, data blocks, or both, associated with the snapshot files stored at the storage 220. For example, the stripe component 250 may be configured to store storage addresses (e.g., logical or physical addresses) for the stripes of the stored snapshot files, metadata for the stored snapshot files, and the like.

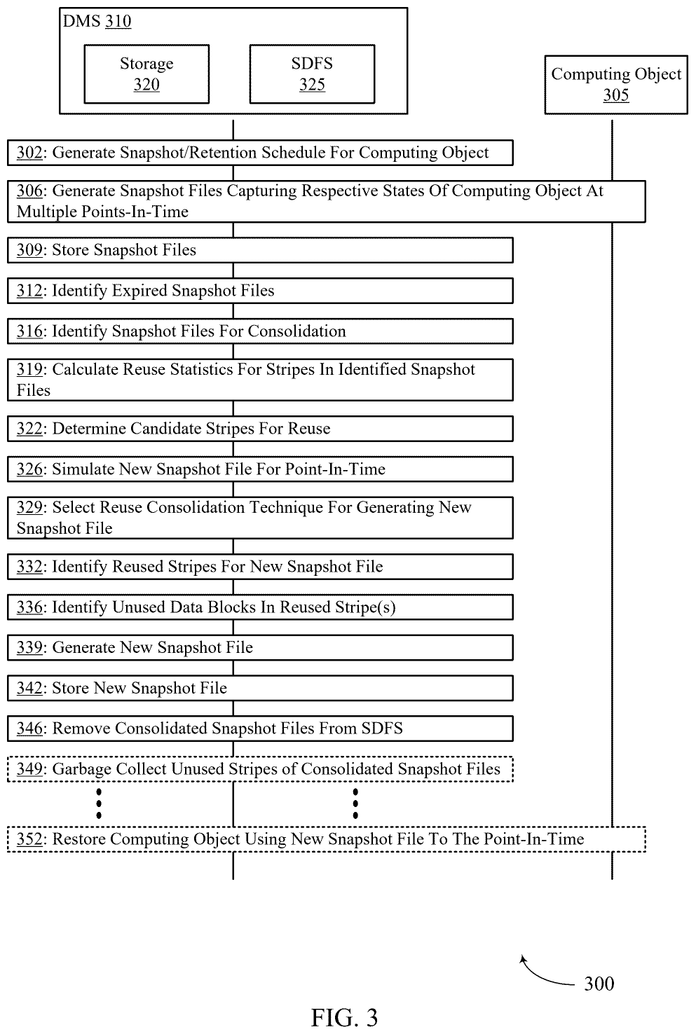

FIG. 3 shows an example of a as set of operations for snapshot consolidation in accordance with aspects of the present disclosure.

The process flow 300 may be performed by the DMS 310 and the computing object 305, which may be respective examples of a DMS (e.g., the DMS 110 of FIG. 1) and a computing object (e.g., one or more aspects of a computing system 105 as described with reference to FIG. 1). The DMS 310 may include the storage 320 (which may be an example of the storage 220 of FIG. 2) and the SDFS 325 (which may be an example of the SDFS 225 of FIG. 2).

In some examples, the process flow 300 shows an example set of operations performed to support snapshot consolidation. For example, the process flow 300 may include operations for executing a reuse consolidate procedure based on determining to utilize a reuse consolidation procedure to consolidate snapshot files.

At 302, a schedule for taking and retaining snapshots of the computing object 305 may be generated. As described herein, a snapshot of a computing object may capture a state of the computing object 305—e.g., a state of a file system of the computing object 305, a state of a database of the computing object 305, a state of a folder of the computing object, etc. The schedule may identify periodic intervals, events, or both for capturing snapshots of the computing object 305. As described herein, the DMS 310 may take one or more full snapshots and one or more incremental snapshots. In some examples, the first snapshot taken of the computing object 305 may be a full snapshot that captures the full state of the computing object 305. In some examples, after taking the full snapshot, subsequent snapshots taken of the computing object 305 may be incremental snapshots that capture differences between the current state of the computing object 305 and the prior state of the computing object 305 captured by the full snapshot. In some examples, after taking the full snapshot, a subsequent snapshot taken of the computing object 305 may be an incremental snapshot that captures differences between the current state of the computing object 305 and the prior state of the computing object 305 captured by the full snapshot, a following snapshot taken of the computing object 305 may be an incremental snapshot that captures differences between the current state of the computing object and the prior state of the computing object 305 captured by the full snapshot and the subsequent incremental snapshot, and so on—e.g., creating a snapshot chain.

In some examples, the DMS 310 may take additional full snapshots of the computing object 305—e.g., periodically, when requested by a customer, after an occurrence of particular events, etc. In some examples, additional snapshot chains may be generated when new full snapshots are taken, where the additional snapshot chains may stem from respective full snapshots. In some examples, the DMS 310 may take a subsequent full snapshot of the computing object 305 when a prior full snapshot of the computing object 305 expires. In some examples, the snapshot chain is modified to depend on the latest full snapshot when a new full snapshot is taken—e.g., the existing incremental snapshots may become reverse incremental snapshots.

The schedule may also identify rules for retaining snapshots as time progresses. For example, the schedule may indicate that from an earliest point in time, to retain the latest snapshot for each year; within the last year, to retain the latest snapshot for each month; within the last month, to retain the latest snapshot for each week; and within the last week, to retain the latest snapshot for each day. In such cases, snapshots that are not covered by the retention schedule may be considered as expired—e.g., a second, earlier-in-time snapshot in a month that has passed. In some examples, a customer may prevent certain snapshots from being deleted even if that snapshot has expired in accordance with the retention schedule.

At 306, snapshot files may be generated to memorialize respective snapshots of the computing object 305 that are taken at different points-in-time in accordance with the snapshot schedule. In some examples, the DMS 310 coordinates with the computing object 305 to take the snapshots—e.g., by coordinating with an agent of the DMS 310 that is installed at the computing object 305.

In some examples, the snapshot files may be generated in accordance with a file format supported by the SDFS 325—e.g., a patchfile format. As described herein, a snapshot file generated in accordance with a patchfile format may organize the underlying data in data blocks, which may be included in one or more stripes.

At 309, the snapshot files taken of the computing object 305 may be stored in the DMS 310—e.g., in the storage 320. In some examples, the structure of the snapshot file may differ from the structure of the storage resources of the storage 320—e.g., the size of the data blocks of the snapshot file may be different than the size of data blocks of the storage 320, the size of the stripes may be different than a size of a data unit in the storage 320 that includes the data blocks of the storage 320, a stripe may be stored across multiple disks of the storage 320 (e.g., to provide redundancy), etc.

In some examples, a first snapshot file of the snapshot files may be stored at a first set of storage locations of the storage 320, a second snapshot file of the snapshot files may be stored at a second set of storage locations of the storage 320, and so on. In some examples, one or more stripes of the respective snapshot files are stored in sequential (e.g., logically, physically, or both) storage locations—e.g., to improve the efficiency, latency, or both, of subsequent access operations.

At 312, one or more expired snapshot files (corresponding to one or more expired snapshots of the computing object 305) may be identified in accordance with the retention schedule. In some examples, one or more of the expired snapshot files corresponds to incremental snapshots of the computing object 305. Additionally, or alternatively, one or more of the expired snapshot files may correspond to full snapshots of the computing object 305.

At 316, one or more snapshot files may be identified for consolidation—e.g., based on identifying the one or more expired snapshot files. In some examples, the snapshot files identified for consolidation may include the snapshot files used to recreate a state of the computing object at a particular point-in-time—e.g., a point-in-time corresponding to the latest snapshot file depending on the one or more expired snapshot files. For example, based on determining that a first incremental snapshot file has expired, it may be determined that data from the first incremental snapshot file and data from a subsequent incremental snapshot file is to be consolidated—e.g., based on the subsequent incremental snapshot file depending from the first incremental snapshot file and the first incremental snapshot file capturing changes to a state of the computing object 305 relative to a full snapshot file that are not also captured, or overwritten, by the subsequent incremental snapshot file.

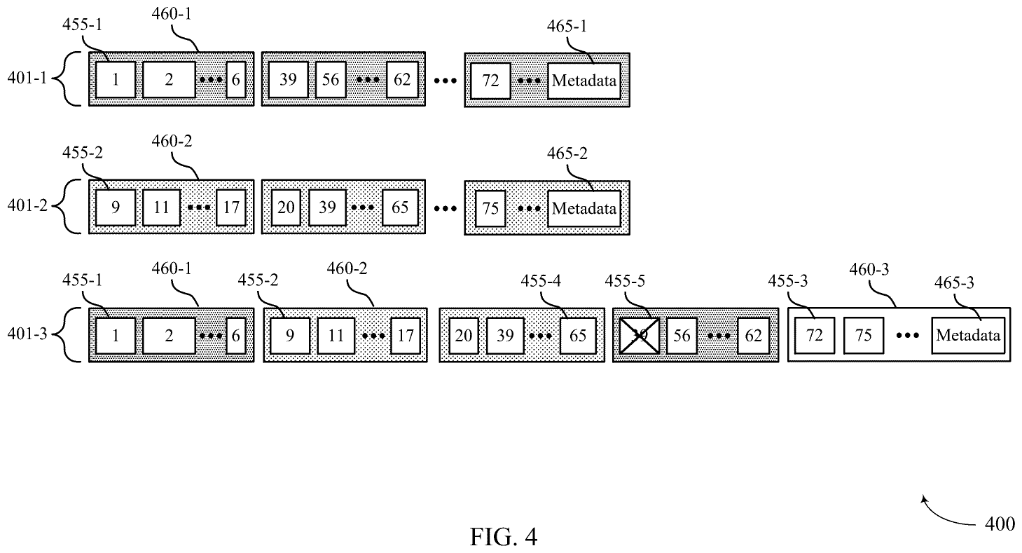

In some examples, the snapshot files identified for consolidation include the first snapshot file 401-1 of FIG. 4 (which may be an expired snapshot file) and the second snapshot file 401-2 of FIG. 4 (which may be a non-expired snapshot file associated with the particular point-in-time).

At 319, based on identifying the snapshot files for consolidation, reuse statistics may be calculated for stripes of the snapshot files identified for consolidation. In some examples, for a first (e.g., expired) snapshot file of the identified snapshot files, a quantity of data blocks in each stripe of the first snapshot file that may be reused (e.g., data blocks that are not overwritten by subsequent expired or non-expired snapshot files depending from the first snapshot file) may be calculated. In some examples, this analysis may be similarly performed for each expired snapshot file of the identified snapshot files. In some examples, all of the stripes in a latest snapshot file may be identified as candidates for reuse.

At 322, stripes in the snapshot files identified for consolidation that are candidates for reuse may be identified. In some examples, the candidate stripes may be identified as those stripes in which a threshold quantity, threshold percentage, or both, of data blocks may be reused. In some examples, the threshold quantity is determined based on running a series of tests associated with accessing simulated snapshot files (e.g., having a predetermined sequentiality) and identifying respective performance metrics—e.g., the threshold quantity may be set based on the minimum reuse factor for which one or more access-related thresholds, processing burden-related thresholds, or both, are exceeded. Additionally, or alternatively, the threshold quantity may be dynamically adjusted based on an amount of free space in the storage 320.

In some examples, a determination of whether to identify a stripe as a candidate for reuse may be further based on whether one or more adjacent stripes are also identified as candidates for reuse—e.g., if a data block in the stripe extends from the stripe into an adjacent subsequent stripe, if a data block in the stripe extends from the stripe into an adjacent preceding stripe, or both.

At 326, a new snapshot file may be simulated for a point-in-time associated with the snapshot files to be consolidated—e.g., the point-in-time corresponding to the latest snapshot file depending on the one or more expired snapshot files. In some examples, the new snapshot file may be simulated based on the candidate stripes identified in the snapshot files to be consolidated. In some examples, in addition to the candidate stripes, simulating the new snapshot file may include generating one or more new stripes including data blocks from stripes in the snapshot files to be consolidated that were not identified as candidate stripes, metadata for the new snapshot file, or both. In some examples, the one or more generated new stripes may include data blocks from stripes in the snapshot files that were identified as candidate stripes—e.g., to improve sequentiality of the new snapshot file.

In some examples, the simulated new snapshot file may correspond to the third snapshot file 401-3 of FIG. 4.

At 329, a determination of whether to select a reuse consolidation technique or a copy consolidation technique may be made based on the simulated snapshot file. In some examples, the sequentiality may be determined based on identifying a quantity of data blocks within the simulated snapshot file that occur out-of-order—e.g., relative to other data blocks within the simulate snapshot file. In some examples, the determination may be made based on a sequentiality of the simulated snapshot file. In some examples, sequentiality is calculated by computing: (number of sequential data blocks/total number of data blocks) * 100, where the total number of blocks may be the number of data blocks in the simulated snapshot file. A data block may be considered sequential if the previous data block in the logical space of the simulated snapshot file is physically contiguous.

In some examples, the reuse consolidation technique may be selected based on determining that a sequentiality of the simulated snapshot file exceeds a threshold. In such cases, a new snapshot file that references the candidate stripes of the snapshot files to be consolidated (instead of copying the content of the candidate stripes to new stripes of the new snapshot file) may be used. By selecting a reuse consolidation technique when the sequentiality of the simulated snapshot file exceeds the threshold, the new snapshot file may be generated with an improved processing efficiency relative to a copy consolidation technique while also being accessed with an efficiency that exceeds a threshold. In some examples, the threshold is determined based on running a series of tests associated with accessing snapshot files in the storage 320 and identifying performance metrics for different sequentiality values—e.g., the threshold may be set based on the minimum sequentiality value for which one or more access-related thresholds, processing burden-related thresholds, or both, are exceeded.

In some examples, the copy consolidation technique may be selected based on determining that the sequentiality of the simulated snapshot file is below the threshold. In such cases, a new snapshot file that includes new stripes and new data blocks generated based on copying the content of the old data blocks in the old stripes of the snapshot files to be consolidated to new data blocks in the new stripes may be used. By selecting a copy consolidation technique when the sequentiality of the simulated snapshot file is below the threshold, the new snapshot file may be accessed with an efficiency that exceeds a threshold.

At 332, the stripes of the snapshot files corresponding to the candidate stripes for reuse may be identified based on selecting the reuse consolidation technique. Identifying the stripes of the snapshot files may further include identifying storage locations in the storage 320 where the candidate stripes are stored.

At 336, unused data blocks in the candidate stripes may be identified. In some examples, unused data blocks in a candidate stripe may correspond to data blocks in a candidate stripe of a first snapshot file that are modified (e.g., overwritten) in a subsequent snapshot file. Additionally, or alternatively, unused data blocks in a candidate stripe may correspond to data blocks in a candidate stripe of a first snapshot file that are written to a new stripe of the new snapshot file (e.g., to improve sequentiality of the new snapshot file).

At 339, a new snapshot file may be generated based on the identified candidate stripes of the snapshots to be consolidated. In some examples, generating the new snapshot file may include indicating, in the new snapshot file, references to the identified candidate stripes—e.g., by referencing the identified candidate stripes themselves at the SDFS level, storage locations where the identified candidate stripes are stored in the storage 320, or both. Generating the new snapshot file may also include generating one or more new stripes to include data blocks included in stripes of the snapshots to be consolidated that are not identified for reuse, data blocks that are copied to the one or more new stripes to improve sequentiality, or the like. In some examples, copying the data blocks to the one or more new stripes may include reading, uncompressing, recompressing, calculating fingerprints for, and rewriting each copied data block.

Generating the new snapshot may further include generating metadata for the new snapshot file. In some examples, the metadata includes information about the new snapshot file (e.g., a point-in-time associated with new snapshot file, whether the new snapshot file is protected from deletion, snapshot files on which the snapshot file depends, etc.), references to the identified candidate stripes (e.g., references to the stripes in the SDFS, storage locations of the identified candidate stripes, or both), and the like. In some examples, the metadata is generated based on metadata in the snapshot files being consolidated. In some examples, the metadata also indicates data blocks in reused stripes that are to be unused in the new snapshot file—e.g., a data block in a reused stripe of a first snapshot file being consolidated that is overwritten in a reused stripe of a subsequent snapshot file being consolidated.

At 342, the new snapshot file may be stored in the storage 320. In some examples, storing the new snapshot file may include storing the new stripes and the generated metadata of the new snapshot file in the storage 320 while the identified stripes of the new snapshot file may already be stored in the storage 320.

At 346, the snapshot files consolidated into the new snapshot file (the “consolidated snapshot files”) may be removed from the SDFS 325. Removing the consolidated snapshot files may include removing references to the consolidated snapshot files without deleting the underlying data from the storage 320. In some examples, the reused stripes from the consolidated snapshot files may be maintained (e.g., by the SDFS 325, the storage 320, or both) as including valid data after the consolidated snapshot files are removed from the SDFS 325. Additionally, or alternatively, the stripes from the consolidated snapshot files that are not reused may be indicated (e.g., by the SDFS 325, the storage 320, or both) as including invalid data after the consolidated snapshot files are removed from the SDFS 325.

At 349, the unused stripes of the consolidated snapshot files may be garbage collected—e.g., at the SDFS level, the storage level, or both. In some examples, the SDFS 325 may identify the unused stripes of the consolidated snapshot files as candidates for garbage collection. In such cases, the SDFS 325 may mark the unused stripes as invalid and remove references to the unused stripes from the SDFS 325. Additionally, or alternatively, the storage 320 may identify that the unused stripes of the consolidated snapshot files have been identified as storing invalid data and may delete the data in the storage locations used to store the unused stripes.

At 352, the computing object 305 may be restored to a point-in-time associated with the new snapshot file—e.g., in response to a request from a customer. In such cases, the DMS 310 may use the new snapshot file, a base full snapshot file, and any intervening snapshot files to restore the computing object 305 to the point-in-time. Restoring the computing object 305 to the point-in-time may include (e.g., based on the metadata in the new snapshot file) accessing the stripes of the full snapshot, the reused stripes of the consolidated snapshot files at their original storage locations, and the new stripes of the new snapshot file to recreate the state of the computing object at the point-in-time.

In some examples, after creating the new snapshot file, each data block in the reused stripes may be read and fingerprints may be calculated for those data blocks. The calculated fingerprints may then be compared with an existing fingerprint files for the consolidated snapshot files. If the calculated fingerprints match the existing fingerprint files, the DMS 310 may determine that the new snapshot file has been successfully created.

Though largely discussed in the context of consolidating incremental snapshot files with one another, the reuse consolidation operations described above may similarly be used to consolidate a full snapshot file (with another full snapshot file or an incremental snapshot file) into new full snapshot files. Accordingly, the reuse consolidation operations may enable full snapshot files to be consolidated with one another or with incremental snapshots where the processing burden associated with a copy consolidation technique (which may involve reading, uncompressing, recompressing, computing a new fingerprint, and rewriting each data block of the full snapshot) may have previously prohibited, or rendered infeasible, such operations.

Aspects of the process flow 300 may be implemented by respective controllers at the respective devices. Additionally, or alternatively, aspects of the process flow 300 may be implemented as instructions stored in memory (e.g., firmware stored in a memory coupled with a controller) at the respective devices. For example, the instructions, when executed by a controller at one of the respective devices, may cause the controller to perform the operations of the process flow 300 performed by that device. Similarly, the instructions, when executed by a controller at the other of the respective devices, may cause the controller to perform the operations of the process flow 300 performed by that device.

One or more of the operations described in the process flow 300 may be performed earlier or later, omitted, replaced, supplemented, or combined with another operation. Also, additional operations described herein may replace, supplement or be combined with one or more of the operations described in the process flow 300.

FIG. 4 shows an example of a diagram for snapshot consolidation in accordance with aspects of the present disclosure.

The diagram 400 depicts an example consolidation of snapshot files into a new snapshot file. Particularly, the diagram 400 depicts an example consolidation of the first snapshot file 401-1 and the second snapshot file 401-2 into the third snapshot file 401-3.

The first snapshot file 401-1 may include multiple stripes, including the first stripe 460-1. Each stripe of the first snapshot file 401-1 may include respective data blocks. For example, the first stripe 460-1 may include multiple data blocks, including the first data block 455-1. In some examples, one or more of the stripes of the first snapshot file 401-1 may include one or more data blocks that includes metadata, e.g., the first metadata 465-1. In some examples, a data block may extend from between stripes in the first snapshot file 401-1. For example, in some examples, a portion of data block number 6 may be included at a beginning of the second stripe of the first snapshot file 401-1.

The second snapshot file 401-2 may include multiple stripes, including the second stripe 460-2. Each stripe of the second snapshot file 401-2 may include respective data blocks. For example, the second stripe 460-2 may include multiple data blocks, including the second data block 455-2. In some examples, one or more of the stripes of the second snapshot file 401-2 may include one or more data blocks that includes metadata, e.g., the second metadata 465-2. In some examples, a data block may extend from between stripes in the second snapshot file 401-2.

The third snapshot file 401-3 may include multiple stripes, including the third stripe 460-3. Each stripe of the third snapshot file 401-3 may include respective data blocks. For example, the third stripe 460-3 may include multiple data blocks, including the third data block 455-3. In some examples, one or more of the stripes of the third snapshot file 401-3 may include one or more data blocks that includes metadata, e.g., the third metadata 465-3. In some examples, a data block may extend from between stripes in the third snapshot file 401-3.

As described herein, the third snapshot file 401-3 may further include stripes from the first snapshot file 401-1 and the second snapshot file 401-2. For example, the third snapshot file 401-3 may include the first stripe 460-1 of the first snapshot file 401-1 and the second stripe 460-2 of the second snapshot file 401-2—e.g., by including references to the first stripe 460-1 and the second stripe 460-2, for example, in the third metadata 465-3, the SDFS files, or both. As also described herein, the third stripe 460-3 of the third snapshot file 401-3 may be generated from corresponding data blocks in the first snapshot file 401-1 and the second snapshot file 401-2.

As additionally described herein, in some examples, one or more data blocks in the reused stripes may be indicated as being unused in the third snapshot file 401-3. For example, the fifth data block 455-5 (e.g., block number 39) in the reused stripe of the first snapshot file 401-1 may be indicated as being unused based on the preceding reused stripe of the second snapshot file 401-2 including a superseding version (e.g., updated block number 39) of the fifth data block 455-5.

As further described herein, in some examples, one or more data blocks in one or more reused stripes may be identified as being out-of-order (e.g., non-sequential). For example, the fourth data block 455-4 (e.g., data block 65) of the reused stripe may have a block number that occurs after block numbers in another stripe of the third snapshot file 401-3. In some examples, a sequentiality of the third snapshot file 401-3 is determined based on a quantity of data blocks in the third snapshot file 401-3 that are out-of-order.

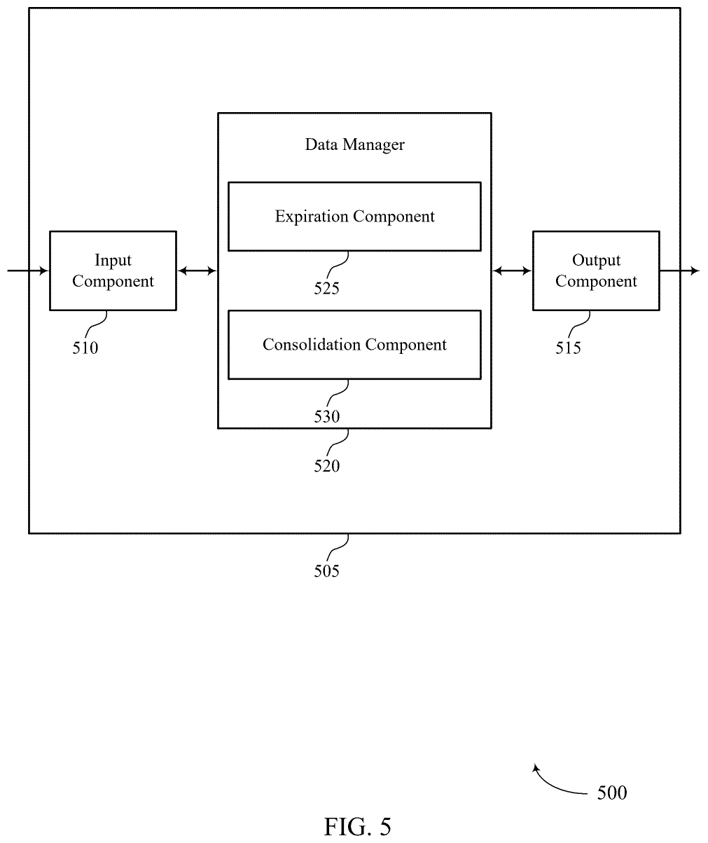

FIG. 5 shows a block diagram 500 of a system 505 that supports snapshot consolidation in accordance with aspects of the present disclosure. In some examples, the system 505 may be an example of aspects of one or more components described with reference to FIG. 1, such as a DMS 110. The system 505 may include an input component 510, an output component 515, and a data manager 520. The system 505 may also include one or more processors. Each of these components may be in communication with one another (e.g., via one or more buses, communications links, communications interfaces, or any combination thereof).

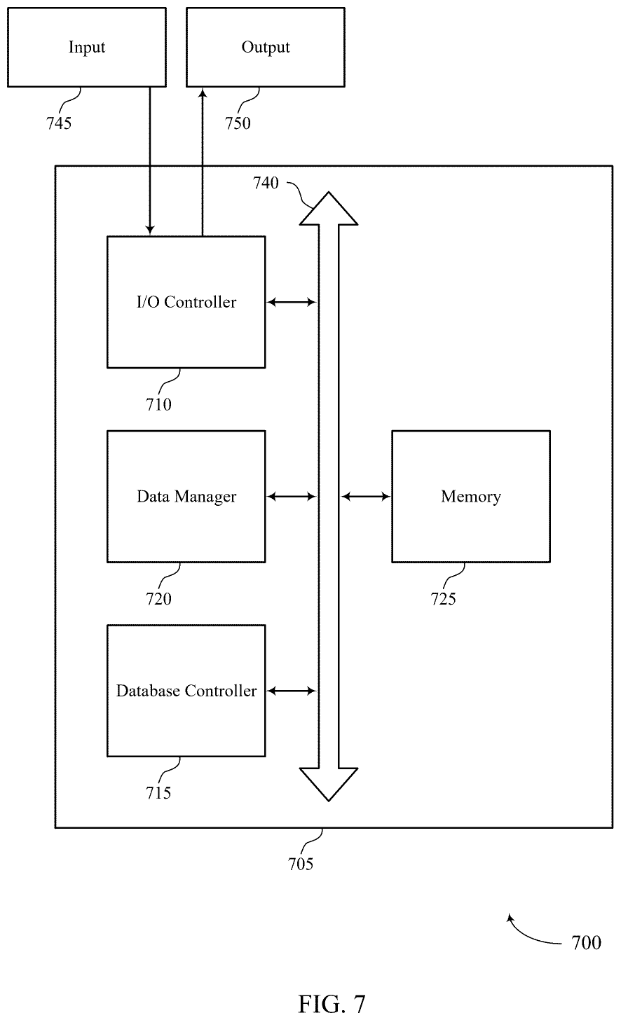

The input component 510 may manage input signals for the system 505. For example, the input component 510 may identify input signals based on an interaction with a modem, a keyboard, a mouse, a touchscreen, or a similar device. These input signals may be associated with user input or processing at other components or devices. In some cases, the input component 510 may utilize an operating system such as iOS®, ANDROID®, MS-DOS®, MS-WINDOWS®, OS/2®, UNIX®, LINUX®, or another known operating system to handle input signals. The input component 510 may send aspects of these input signals to other components of the system 505 for processing. For example, the input component 510 may transmit input signals to the data manager 520 to support snapshot consolidation. In some cases, the input component 510 may be a component of an I/O controller 710 as described with reference to FIG. 7.

The output component 515 may manage output signals for the system 505. For example, the output component 515 may receive signals from other components of the system 505, such as the data manager 520, and may transmit these signals to other components or devices. In some specific examples, the output component 515 may transmit output signals for display in a user interface, for storage in a database or data store, for further processing at a server or server cluster, or for any other processes at any number of devices or systems. In some cases, the output component 515 may be a component of an I/O controller 710 as described with reference to FIG. 7.

For example, the data manager 520 may include an expiration component 525 a consolidation component 530, or any combination thereof. In some examples, the data manager 520, or various components thereof, may be configured to perform various operations (e.g., receiving, monitoring, transmitting) using or otherwise in cooperation with the input component 510, the output component 515, or both. For example, the data manager 520 may receive information from the input component 510, send information to the output component 515, or be integrated in combination with the input component 510, the output component 515, or both to receive information, transmit information, or perform various other operations as described herein.

The expiration component 525 may be configured as or otherwise support a means for identifying, from among a set of multiple snapshot files of a computing object stored at a DMS, that a first snapshot file representing a first state of the computing object at a first point-in-time is expired, where the first snapshot file is partitioned into a first set of data portions stored at a first set of storage locations at the DMS, and where a second snapshot file representing a second state of the computing object at a second point-in-time is partitioned into a second set of data portions stored at a second set of storage locations at the DMS. The consolidation component 530 may be configured as or otherwise support a means for generating, based on identifying that the first snapshot file is expired, from the first snapshot file and the second snapshot file, a third snapshot file representing the second state of the computing object at the second point-in-time, where the third snapshot file is partitioned into a third set of data portions, one or more first data portions of the third set of data portions being stored at one or more storage locations within the first set of storage locations and one or more second data portions of the third set of data portions being stored at one or more storage locations within the second set of storage locations.

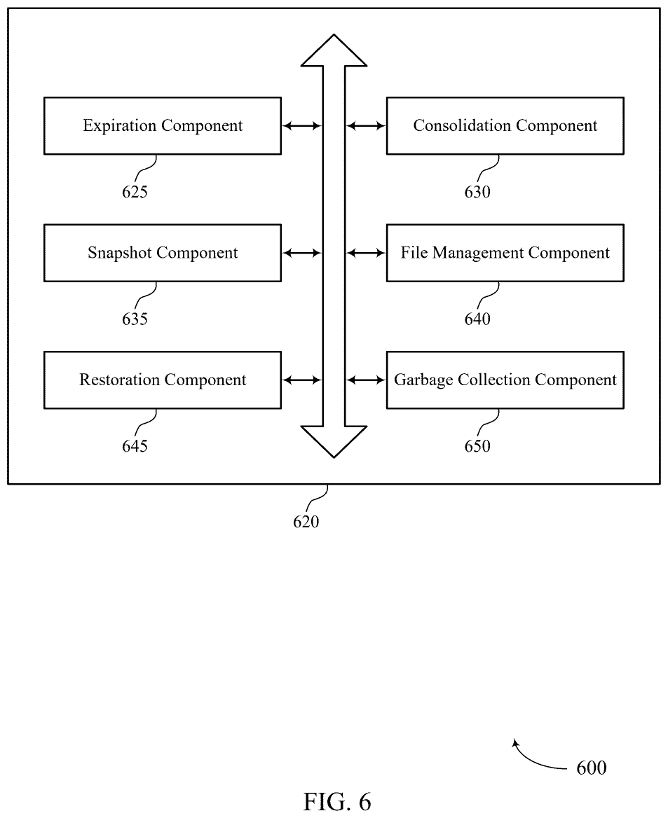

FIG. 6 shows a block diagram 600 of an data manager 620 that supports snapshot consolidation in accordance with aspects of the present disclosure. The data manager 620 may be an example of aspects of an data manager or an data manager 520, or both, as described herein. The data manager 620, or various components thereof, may be an example of means for performing various aspects of snapshot consolidation as described herein. For example, the data manager 620 may include an expiration component 625, a consolidation component 630, a snapshot component 635, a file management component 640, a restoration component 645, a garbage collection component 650, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The expiration component 625 may be configured as or otherwise support a means for identifying, from among a set of multiple snapshot files of a computing object stored at a DMS, that a first snapshot file representing a first state of the computing object at a first point-in-time is expired, where the first snapshot file is partitioned into a first set of data portions stored at a first set of storage locations at the DMS, and where a second snapshot file representing a second state of the computing object at a second point-in-time is partitioned into a second set of data portions stored at a second set of storage locations at the DMS. The consolidation component 630 may be configured as or otherwise support a means for generating, based on identifying that the first snapshot file is expired, from the first snapshot file and the second snapshot file, a third snapshot file representing the second state of the computing object at the second point-in-time, where the third snapshot file is partitioned into a third set of data portions, one or more first data portions of the third set of data portions being stored at one or more storage locations within the first set of storage locations and one or more second data portions of the third set of data portions being stored at one or more storage locations within the second set of storage locations.

In some examples, the snapshot component 635 may be configured as or otherwise support a means for generating, prior to the first snapshot file being expired, the set of multiple snapshot files for the computing object, the set of multiple snapshot files including at least one full snapshot file and a set of multiple incremental snapshot files, where the set of multiple incremental snapshot files includes the first snapshot file and the second snapshot file.

In some examples, the consolidation component 630 may be configured as or otherwise support a means for determining, based on the first snapshot file being expired, that the first snapshot file stores first data for restoring the computing object to the second point-in-time and the second snapshot file stores second data for restoring the computing object to the second point-in-time. In some examples, the consolidation component 630 may be configured as or otherwise support a means for consolidating, based on the first snapshot file and the second snapshot file both storing data for restoring the computing object to the second point-in-time, the first data in the first snapshot file and the second data in the second snapshot file, where the third snapshot file is generated based on the consolidating.

In some examples, the consolidation component 630 may be configured as or otherwise support a means for selecting, based on the first snapshot file being expired and on both the first snapshot file and the second snapshot file storing data for restoring the computing object to the second point-in-time, a consolidation technique to generate the third snapshot file, where selection of the consolidation technique is between at least a reuse consolidation technique that is associated with including references to one or more of the first set of data portions at the first set of storage locations and to one or more of the second set of data portions at the second set of storage locations in the third snapshot file and a copy consolidation technique that is associated with copying, to a third set of storage locations associated with the third snapshot file, data blocks in one or more of the first set of data portions from the first set of storage locations and data blocks in the second set of data portions from the second set of storage locations.

In some examples, the consolidation component 630 may be configured as or otherwise support a means for calculating, based on the first snapshot file and the second snapshot file, a sequentiality of a potential snapshot file that consolidates the data for restoring the computing object, where the reuse consolidation technique is selected to generate the third snapshot file based on the sequentiality of the potential snapshot file exceeding a threshold.

In some examples, the consolidation component 630 may be configured as or otherwise support a means for determining, based on the first snapshot file being expired and further based on to the third snapshot file being generated via a reuse consolidation technique, that a set of data blocks in a first data portion of the first set of data portions of the first snapshot file is to be included in the third snapshot file, the first data portion being stored at a first storage location of the first set of storage locations. In some examples, the consolidation component 630 may be configured as or otherwise support a means for selecting, based on determining that the set of data blocks in the first data portion is to be included in the third snapshot file, an inclusion technique for including the set of data blocks in the third snapshot file, where selection of the inclusion technique is between at least a first inclusion technique that includes including, in the third snapshot file, a reference to the first storage location storing the first data portion and a second inclusion technique that includes copying the set of data blocks to one or more third data portions of the third set of data portions stored at one or more third storage locations at the DMS, where the third snapshot file is generated in accordance with the selected inclusion technique.

In some examples, the first inclusion technique that includes including the reference to the first storage location in the third snapshot file is selected based on a percentage of data blocks in the first data portion used for restoring the computing object to the second point-in-time satisfying a threshold percentage.

In some examples, the garbage collection component 650 may be configured as or otherwise support a means for marking, based on including the reference to the first storage location in the third snapshot file, a second set of data blocks in the first data portion as unused for restoring the computing object to the second point-in-time.

In some examples, a data block of the set of data blocks is also included in a second data portion of the first set of data portions, the second data portion being stored at a second storage location of the first set of storage locations, and the first inclusion technique that includes including the reference to the first storage location in the third snapshot file is selected based on a determination to also include, in the third snapshot file, a second reference to the second storage location.

In some examples, the first snapshot file is associated with a full snapshot of the computing object and the second snapshot file is associated with an incremental snapshot of the computing object.

In some examples, the file management component 640 may be configured as or otherwise support a means for deleting, based on generating the third snapshot file, a reference to the first snapshot file and a reference to the second snapshot file from a file system of the DMS, where, after the reference to the first snapshot file and the reference to the second snapshot file are deleted from the file system, the one or more storage locations within the first set of storage locations storing one or more first data portions of the first set of data portions of the first snapshot file remain valid, the one or more storage locations within the second set of storage locations storing one or more first data portions of the second set of data portions of the second snapshot file remain valid, one or more second storage locations within the first set of storage locations storing one or more second data portions of the first set of data portions of the first snapshot file become invalid, and one or more second storage locations within the second set of storage locations storing one or more second data portions of the second set of data portions of the second snapshot file become invalid.

In some examples, the file management component 640 may be configured as or otherwise support a means for erasing, based on the one or more second storage locations within the first set of storage locations and the one or more second storage locations within the second set of storage locations being marked as invalid, during a garbage collection operation, the one or more second data portions of the first set of data portions of the first snapshot file from the one or more second storage locations within the first set of storage locations and the one or more second data portions of the second set of data portions of the second snapshot file from the one or more second storage locations within the second set of storage locations.

In some examples, the restoration component 645 may be configured as or otherwise support a means for receiving, based on generating the third snapshot file, a request to restore the computing object to the second point-in-time. In some examples, the restoration component 645 may be configured as or otherwise support a means for accessing, in response to the request, the third snapshot file, where accessing the third snapshot file includes reading the one or more first data portions of the third set of data portions of the third snapshot file from the one or more storage locations within the first set of storage locations, the one or more second data portions of the third set of data portions from the one or more storage locations within the second set of storage locations, and one or more third data portions of the third set of data portions from a third set of storage locations at the DMS. In some examples, the restoration component 645 may be configured as or otherwise support a means for restoring, after accessing the third snapshot file, the computing object to the second point-in-time in accordance with the third snapshot file.

FIG. 7 shows a block diagram 700 of a system 705 that supports snapshot consolidation in accordance with aspects of the present disclosure. The system 705 may be an example of or include components of a system 505 as described herein. The system 705 may include components for data management, including components such as an data manager 720, an I/O controller, such as an I/O controller 710, a database controller 715, at least one memory 725, at least one processor 730, and a database 735. These components may be in electronic communication or otherwise coupled with each other (e.g., operatively, communicatively, functionally, electronically, electrically; via one or more buses, communications links, communications interfaces, or any combination thereof). Additionally, the components of the system 705 may include corresponding physical components or may be implemented as corresponding virtual components (e.g., components of one or more virtual machines). In some examples, the system 705 may be an example of aspects of one or more components described with reference to FIG. 1, such as a DMS 110.

The I/O controller 710 may manage input signals 745 and output signals 750 for the system 705. The I/O controller 710 may also manage peripherals not integrated into the system 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor. In some examples, a user may interact with the system 705 via the I/O controller 710 or via hardware components controlled by the I/O controller 710.

The database controller 715 may manage data storage and processing in a database 735. The database 735 may be external to the system 705, temporarily or permanently connected to the system 705, or a data storage component of the system 705. In some cases, a user may interact with the database controller 715. In some other cases, the database controller 715 may operate automatically without user interaction. The database 735 may be an example of a persistent data store, a single database, a distributed database, multiple distributed databases, a database management system, or an emergency backup database.

Memory 725 may include random-access memory (RAM) and ROM. The memory 725 may store computer-readable, computer-executable software including instructions that, when executed, cause the processor to perform various functions described herein. In some cases, the memory 725 may contain, among other things, a BIOS which may control basic hardware or software operation such as the interaction with peripheral components or devices.

The processor 730 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 730 may be configured to operate a memory array using a memory controller. In some other cases, a memory controller may be integrated into the processor 730. The processor 730 may be configured to execute computer-readable instructions stored in memory 725 to perform various functions (e.g., functions or tasks supporting snapshot consolidation).

For example, the data manager 720 may be configured as or otherwise support a means for identifying, from among a set of multiple snapshot files of a computing object stored at a DMS, that a first snapshot file representing a first state of the computing object at a first point-in-time is expired, where the first snapshot file is partitioned into a first set of data portions stored at a first set of storage locations at the DMS, and where a second snapshot file representing a second state of the computing object at a second point-in-time is partitioned into a second set of data portions stored at a second set of storage locations at the DMS. The data manager 720 may be configured as or otherwise support a means for generating, based on identifying that the first snapshot file is expired, from the first snapshot file and the second snapshot file, a third snapshot file representing the second state of the computing object at the second point-in-time, where the third snapshot file is partitioned into a third set of data portions, one or more first data portions of the third set of data portions being stored at one or more storage locations within the first set of storage locations and one or more second data portions of the third set of data portions being stored at one or more storage locations within the second set of storage locations.

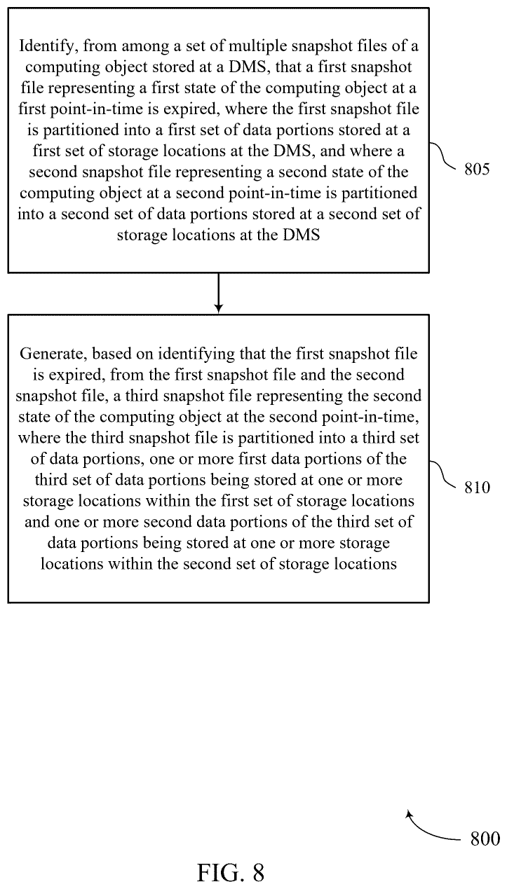

FIG. 8 shows a flowchart illustrating a method 800 that supports snapshot consolidation in accordance with aspects of the present disclosure. The operations of the method 800 may be implemented by a data management system or its components as described herein. For example, the operations of the method 800 may be performed by a data management system as described with reference to FIGS. 1 through 7. In some examples, a data management system may execute a set of instructions to control the functional elements of the data management system to perform the described functions. Additionally, or alternatively, the data management system may perform aspects of the described functions using special-purpose hardware.

At 805, the method may include identifying, from among a set of multiple snapshot files of a computing object stored at a DMS, that a first snapshot file representing a first state of the computing object at a first point-in-time is expired, where the first snapshot file is partitioned into a first set of data portions stored at a first set of storage locations at the DMS, and where a second snapshot file representing a second state of the computing object at a second point-in-time is partitioned into a second set of data portions stored at a second set of storage locations at the DMS. The operations of 805 may be performed in accordance with examples as disclosed herein. In some examples, aspects of the operations of 805 may be performed by an expiration component 625 as described with reference to FIG. 6.

At 810, the method may include generating, based on identifying that the first snapshot file is expired, from the first snapshot file and the second snapshot file, a third snapshot file representing the second state of the computing object at the second point-in-time, where the third snapshot file is partitioned into a third set of data portions, one or more first data portions of the third set of data portions being stored at one or more storage locations within the first set of storage locations and one or more second data portions of the third set of data portions being stored at one or more storage locations within the second set of storage locations. The operations of 810 may be performed in accordance with examples as disclosed herein. In some examples, aspects of the operations of 810 may be performed by a consolidation component 630 as described with reference to FIG. 6.

A method by an apparatus is described. The method may include identifying, from among a set of multiple snapshot files of a computing object stored at a DMS, that a first snapshot file representing a first state of the computing object at a first point-in-time is expired, where the first snapshot file is partitioned into a first set of data portions stored at a first set of storage locations at the DMS, and where a second snapshot file representing a second state of the computing object at a second point-in-time is partitioned into a second set of data portions stored at a second set of storage locations at the DMS and generating, based on identifying that the first snapshot file is expired, from the first snapshot file and the second snapshot file, a third snapshot file representing the second state of the computing object at the second point-in-time, where the third snapshot file is partitioned into a third set of data portions, one or more first data portions of the third set of data portions being stored at one or more storage locations within the first set of storage locations and one or more second data portions of the third set of data portions being stored at one or more storage locations within the second set of storage locations.

An apparatus is described. The apparatus may include one or more memories storing processor executable code, and one or more processors coupled with the one or more memories. The one or more processors may individually or collectively be operable to execute the code to cause the apparatus to identify, from among a set of multiple snapshot files of a computing object stored at a DMS, that a first snapshot file representing a first state of the computing object at a first point-in-time is expired, where the first snapshot file is partitioned into a first set of data portions stored at a first set of storage locations at the DMS, and where a second snapshot file representing a second state of the computing object at a second point-in-time is partitioned into a second set of data portions stored at a second set of storage locations at the DMS and generate, based on identifying that the first snapshot file is expired, from the first snapshot file and the second snapshot file, a third snapshot file representing the second state of the computing object at the second point-in-time, where the third snapshot file is partitioned into a third set of data portions, one or more first data portions of the third set of data portions being stored at one or more storage locations within the first set of storage locations and one or more second data portions of the third set of data portions being stored at one or more storage locations within the second set of storage locations.

Another apparatus is described. The apparatus may include means for identifying, from among a set of multiple snapshot files of a computing object stored at a DMS, that a first snapshot file representing a first state of the computing object at a first point-in-time is expired, where the first snapshot file is partitioned into a first set of data portions stored at a first set of storage locations at the DMS, and where a second snapshot file representing a second state of the computing object at a second point-in-time is partitioned into a second set of data portions stored at a second set of storage locations at the DMS and means for generating, based on identifying that the first snapshot file is expired, from the first snapshot file and the second snapshot file, a third snapshot file representing the second state of the computing object at the second point-in-time, where the third snapshot file is partitioned into a third set of data portions, one or more first data portions of the third set of data portions being stored at one or more storage locations within the first set of storage locations and one or more second data portions of the third set of data portions being stored at one or more storage locations within the second set of storage locations.

A non-transitory computer-readable medium storing code is described. The code may include instructions executable by one or more processors to identify, from among a set of multiple snapshot files of a computing object stored at a DMS, that a first snapshot file representing a first state of the computing object at a first point-in-time is expired, where the first snapshot file is partitioned into a first set of data portions stored at a first set of storage locations at the DMS, and where a second snapshot file representing a second state of the computing object at a second point-in-time is partitioned into a second set of data portions stored at a second set of storage locations at the DMS and generate, based on identifying that the first snapshot file is expired, from the first snapshot file and the second snapshot file, a third snapshot file representing the second state of the computing object at the second point-in-time, where the third snapshot file is partitioned into a third set of data portions, one or more first data portions of the third set of data portions being stored at one or more storage locations within the first set of storage locations and one or more second data portions of the third set of data portions being stored at one or more storage locations within the second set of storage locations.

Some examples of the method, apparatus, and non-transitory computer-readable medium described herein may further include operations, features, means, or instructions for generating, prior to the first snapshot file being expired, the set of multiple snapshot files for the computing object, the set of multiple snapshot files including at least one full snapshot file and a set of multiple incremental snapshot files, where the set of multiple incremental snapshot files includes the first snapshot file and the second snapshot file.

Some examples of the method, apparatus, and non-transitory computer-readable medium described herein may further include operations, features, means, or instructions for determining, based on the first snapshot file being expired, that the first snapshot file stores first data for restoring the computing object to the second point-in-time and the second snapshot file stores second data for restoring the computing object to the second point-in-time and consolidating, based on the first snapshot file and the second snapshot file both storing data for restoring the computing object to the second point-in-time, the first data in the first snapshot file and the second data in the second snapshot file, where the third snapshot file may be generated based on the consolidating.

Some examples of the method, apparatus, and non-transitory computer-readable medium described herein may further include operations, features, means, or instructions for selecting, based on the first snapshot file being expired and on both the first snapshot file and the second snapshot file storing data for restoring the computing object to the second point-in-time, a consolidation technique to generate the third snapshot file, where selection of the consolidation technique may be between at least a reuse consolidation technique that may be associated with including references to one or more of the first set of data portions at the first set of storage locations and to one or more of the second set of data portions at the second set of storage locations in the third snapshot file and a copy consolidation technique that may be associated with copying, to a third set of storage locations associated with the third snapshot file, data blocks in one or more of the first set of data portions from the first set of storage locations and data blocks in the second set of data portions from the second set of storage locations.

Some examples of the method, apparatus, and non-transitory computer-readable medium described herein may further include operations, features, means, or instructions for calculating, based on the first snapshot file and the second snapshot file, a sequentiality of a potential snapshot file that consolidates the data for restoring the computing object, where the reuse consolidation technique may be selected to generate the third snapshot file based on the sequentiality of the potential snapshot file exceeding a threshold.

Some examples of the method, apparatus, and non-transitory computer-readable medium described herein may further include operations, features, means, or instructions for determining, based on the first snapshot file being expired and further based on to the third snapshot file being generated via a reuse consolidation technique, that a set of data blocks in a first data portion of the first set of data portions of the first snapshot file may be to be included in the third snapshot file, the first data portion being stored at a first storage location of the first set of storage locations and selecting, based on determining that the set of data blocks in the first data portion may be to be included in the third snapshot file, an inclusion technique for including the set of data blocks in the third snapshot file, where selection of the inclusion technique may be between at least a first inclusion technique that includes including, in the third snapshot file, a reference to the first storage location storing the first data portion and a second inclusion technique that includes copying the set of data blocks to one or more third data portions of the third set of data portions stored at one or more third storage locations at the DMS, where the third snapshot file may be generated in accordance with the selected inclusion technique.

In some examples of the method, apparatus, and non-transitory computer-readable medium described herein, the first inclusion technique that includes including the reference to the first storage location in the third snapshot file may be selected based on a percentage of data blocks in the first data portion used for restoring the computing object to the second point-in-time satisfying a threshold percentage.

Some examples of the method, apparatus, and non-transitory computer-readable medium described herein may further include operations, features, means, or instructions for marking, based on including the reference to the first storage location in the third snapshot file, a second set of data blocks in the first data portion as unused for restoring the computing object to the second point-in-time.

In some examples of the method, apparatus, and non-transitory computer-readable medium described herein, a data block of the set of data blocks may be also included in a second data portion of the first set of data portions, the second data portion being stored at a second storage location of the first set of storage locations, and the first inclusion technique that includes including the reference to the first storage location in the third snapshot file may be selected based on a determination to also include, in the third snapshot file, a second reference to the second storage location.

In some examples of the method, apparatus, and non-transitory computer-readable medium described herein, the first snapshot file may be associated with a full snapshot of the computing object and the second snapshot file may be associated with an incremental snapshot of the computing object.

Some examples of the method, apparatus, and non-transitory computer-readable medium described herein may further include operations, features, means, or instructions for deleting, based on generating the third snapshot file, a reference to the first snapshot file and a reference to the second snapshot file from a file system of the DMS, where, after the reference to the first snapshot file and the reference to the second snapshot file may be deleted from the file system, the one or more storage locations within the first set of storage locations storing one or more first data portions of the first set of data portions of the first snapshot file remain valid, the one or more storage locations within the second set of storage locations storing one or more first data portions of the second set of data portions of the second snapshot file remain valid, one or more second storage locations within the first set of storage locations storing one or more second data portions of the first set of data portions of the first snapshot file become invalid, and one or more second storage locations within the second set of storage locations storing one or more second data portions of the second set of data portions of the second snapshot file become invalid.

Some examples of the method, apparatus, and non-transitory computer-readable medium described herein may further include operations, features, means, or instructions for erasing, based on the one or more second storage locations within the first set of storage locations and the one or more second storage locations within the second set of storage locations being marked as invalid, during a garbage collection operation, the one or more second data portions of the first set of data portions of the first snapshot file from the one or more second storage locations within the first set of storage locations and the one or more second data portions of the second set of data portions of the second snapshot file from the one or more second storage locations within the second set of storage locations.

Some examples of the method, apparatus, and non-transitory computer-readable medium described herein may further include operations, features, means, or instructions for receiving, based on generating the third snapshot file, a request to restore the computing object to the second point-in-time, accessing, in response to the request, the third snapshot file, where accessing the third snapshot file includes reading the one or more first data portions of the third set of data portions of the third snapshot file from the one or more storage locations within the first set of storage locations, the one or more second data portions of the third set of data portions from the one or more storage locations within the second set of storage locations, and one or more third data portions of the third set of data portions from a third set of storage locations at the DMS, and restoring, after accessing the third snapshot file, the computing object to the second point-in-time in accordance with the third snapshot file.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
identifying, from among a plurality of snapshot files of a computing object stored at a data management system (DMS), that a first snapshot file representing a first state of the computing object at a first point-in-time is expired, wherein the first snapshot file is partitioned into a first set of data portions stored at a first set of storage locations at the DMS, and wherein a second snapshot file representing a second state of the computing object at a second point-in-time is partitioned into a second set of data portions stored at a second set of storage locations at the DMS; and
generating, based at least in part on identifying that the first snapshot file is expired, from the first snapshot file and the second snapshot file, a third snapshot file representing the second state of the computing object at the second point-in-time, wherein:
the third snapshot file is partitioned into a third set of data portions, one or more first data portions of the third set of data portions being stored at one or more storage locations within the first set of storage locations and one or more second data portions of the third set of data portions being stored at one or more storage locations within the second set of storage locations.

2. The method of claim 1, further comprising:
generating, prior to the first snapshot file being expired, the plurality of snapshot files for the computing object, the plurality of snapshot files comprising at least one full snapshot file and a plurality of incremental snapshot files, wherein the plurality of incremental snapshot files comprises the first snapshot file and the second snapshot file.

3. The method of claim 1, further comprising:
determining, based at least in part on the first snapshot file being expired, that the first snapshot file stores first data for restoring the computing object to the second point-in-time and the second snapshot file stores second data for restoring the computing object to the second point-in-time; and
consolidating, based at least in part on the first snapshot file and the second snapshot file both storing data for restoring the computing object to the second point-in-time, the first data in the first snapshot file and the second data in the second snapshot file, wherein the third snapshot file is generated based at least in part on the consolidating.

4. The method of claim 1, further comprising:
selecting, based at least in part on the first snapshot file being expired and on both the first snapshot file and the second snapshot file storing data for restoring the computing object to the second point-in-time, a consolidation technique to generate the third snapshot file, wherein selection of the consolidation technique is between at least:
a reuse consolidation technique that is associated with including references to one or more of the first set of data portions at the first set of storage locations and to one or more of the second set of data portions at the second set of storage locations in the third snapshot file; and
a copy consolidation technique that is associated with copying, to a third set of storage locations associated with the third snapshot file, data blocks in one or more of the first set of data portions from the first set of storage locations and data blocks in the second set of data portions from the second set of storage locations.

5. The method of claim 4, further comprising:
calculating, based at least in part on the first snapshot file and the second snapshot file, a sequentiality of a potential snapshot file that consolidates the data for restoring the computing object, wherein the reuse consolidation technique is selected to generate the third snapshot file based at least in part on the sequentiality of the potential snapshot file exceeding a threshold.

6. The method of claim 1, further comprising:
determining, based at least in part on the first snapshot file being expired and further based at least in part on to the third snapshot file being generated via a reuse consolidation technique, that a set of data blocks in a first data portion of the first set of data portions of the first snapshot file is to be included in the third snapshot file, the first data portion being stored at a first storage location of the first set of storage locations; and
selecting, based at least in part on determining that the set of data blocks in the first data portion is to be included in the third snapshot file, an inclusion technique for including the set of data blocks in the third snapshot file, wherein selection of the inclusion technique is between at least:
a first inclusion technique that comprises including, in the third snapshot file, a reference to the first storage location storing the first data portion; and
a second inclusion technique that comprises copying the set of data blocks to one or more third data portions of the third set of data portions stored at one or more third storage locations at the DMS,
wherein the third snapshot file is generated in accordance with the inclusion technique that is selected.

7. The method of claim 6, wherein the first inclusion technique that comprises including the reference to the first storage location in the third snapshot file is selected based at least in part on a percentage of data blocks in the first data portion used for restoring the computing object to the second point-in-time satisfying a threshold percentage.

8. The method of claim 6, further comprising:
marking, based at least in part on including the reference to the first storage location in the third snapshot file, a second set of data blocks in the first data portion as unused for restoring the computing object to the second point-in-time.

9. The method of claim 6, wherein:
a data block of the set of data blocks is also included in a second data portion of the first set of data portions, the second data portion being stored at a second storage location of the first set of storage locations, and
the first inclusion technique that comprises including the reference to the first storage location in the third snapshot file is selected based at least in part on a determination to also include, in the third snapshot file, a second reference to the second storage location.

10. The method of claim 1, wherein the first snapshot file is associated with a full snapshot of the computing object and the second snapshot file is associated with an incremental snapshot of the computing object.

11. The method of claim 1, further comprising:
deleting, based at least in part on generating the third snapshot file, a reference to the first snapshot file and a reference to the second snapshot file from a file system of the DMS, wherein, after the reference to the first snapshot file and the reference to the second snapshot file are deleted from the file system:
the one or more storage locations within the first set of storage locations storing one or more first data portions of the first set of data portions of the first snapshot file remain valid,
the one or more storage locations within the second set of storage locations storing one or more first data portions of the second set of data portions of the second snapshot file remain valid,
one or more second storage locations within the first set of storage locations storing one or more second data portions of the first set of data portions of the first snapshot file become invalid, and
one or more second storage locations within the second set of storage locations storing one or more second data portions of the second set of data portions of the second snapshot file become invalid.

12. The method of claim 11, further comprising:
erasing, based at least in part on the one or more second storage locations within the first set of storage locations and the one or more second storage locations within the second set of storage locations being marked as invalid, during a garbage collection operation, the one or more second data portions of the first set of data portions of the first snapshot file from the one or more second storage locations within the first set of storage locations and the one or more second data portions of the second set of data portions of the second snapshot file from the one or more second storage locations within the second set of storage locations.

13. The method of claim 1, further comprising:
receiving, based at least in part on generating the third snapshot file, a request to restore the computing object to the second point-in-time;
accessing, in response to the request, the third snapshot file, wherein accessing the third snapshot file comprises:
reading the one or more first data portions of the third set of data portions of the third snapshot file from the one or more storage locations within the first set of storage locations, the one or more second data portions of the third set of data portions from the one or more storage locations within the second set of storage locations, and one or more third data portions of the third set of data portions from a third set of storage locations at the DMS; and
restoring, after accessing the third snapshot file, the computing object to the second point-in-time in accordance with the third snapshot file.

14. An apparatus, comprising:
one or more memories; and
one or more processors, wherein the one or more memories store code comprising instructions executable, individually or collectively, by the one or more processors to cause the apparatus to:
identify, from among a plurality of snapshot files of a computing object stored at a data management system (DMS), that a first snapshot file representing a first state of the computing object at a first point-in-time is expired, wherein the first snapshot file is partitioned into a first set of data portions stored at a first set of storage locations at the DMS, and wherein a second snapshot file representing a second state of the computing object at a second point-in-time is partitioned into a second set of data portions stored at a second set of storage locations at the DMS; and
generate, based at least in part on identifying that the first snapshot file is expired, from the first snapshot file and the second snapshot file, a third snapshot file representing the second state of the computing object at the second point-in-time, wherein:
the third snapshot file is partitioned into a third set of data portions, one or more first data portions of the third set of data portions being stored at one or more storage locations within the first set of storage locations and one or more second data portions of the third set of data portions being stored at one or more storage locations within the second set of storage locations.

15. The apparatus of claim 14, wherein the instructions are further executable, individually or collectively, by the one or more processors to cause the apparatus to:
generate, prior to the first snapshot file being expired, the plurality of snapshot files for the computing object, the plurality of snapshot files comprising at least one full snapshot file and a plurality of incremental snapshot files, wherein the plurality of incremental snapshot files comprises the first snapshot file and the second snapshot file.

16. The apparatus of claim 14, wherein the instructions are further executable, individually or collectively, by the one or more processors to cause the apparatus to:
determine, based at least in part on the first snapshot file being expired, that the first snapshot file stores first data for restoring the computing object to the second point-in-time and the second snapshot file stores second data for restoring the computing object to the second point-in-time; and
consolidate, based at least in part on the first snapshot file and the second snapshot file both storing data for restoring the computing object to the second point-in-time, the first data in the first snapshot file and the second data in the second snapshot file, wherein the third snapshot file is generated based at least in part on the consolidating.

17. The apparatus of claim 14, wherein the instructions are further executable, individually or collectively, by the one or more processors to cause the apparatus to:
select, based at least in part on the first snapshot file being expired and on both the first snapshot file and the second snapshot file storing data for restoring the computing object to the second point-in-time, a consolidation technique to generate the third snapshot file, wherein selection of the consolidation technique is between at least:
a reuse consolidation technique that is associated with including references to one or more of the first set of data portions at the first set of storage locations and to one or more of the second set of data portions at the second set of storage locations in the third snapshot file, and
a copy consolidation technique that is associated with copying, to a third set of storage locations associated with the third snapshot file, data blocks in one or more of the first set of data portions from the first set of storage locations and data blocks in the second set of data portions from the second set of storage locations.

18. The apparatus of claim 14, wherein the instructions are further executable, individually or collectively, by the one or more processors to cause the apparatus to:
determine, based at least in part on the first snapshot file being expired and further based at least in part on to the third snapshot file being generated via a reuse consolidation technique, that a set of data blocks in a first data portion of the first set of data portions of the first snapshot file is to be included in the third snapshot file, the first data portion being stored at a first storage location of the first set of storage locations; and
determine, based at least in part on determining that the set of data blocks in the first data portion is to be included in the third snapshot file, an inclusion technique for including the set of data blocks in the third snapshot file, wherein selection of the inclusion technique is between at least:
a first inclusion technique that comprises including, in the third snapshot file, a reference to the first storage location storing the first data portion; and
a second inclusion technique that comprises copying the set of data blocks to one or more third data portions of the third set of data portions stored at one or more third storage locations at the DMS,
wherein the third snapshot file is generated in accordance with the inclusion technique that is selected.

19. A non-transitory, computer-readable medium storing code that comprises instructions that are executable, individually or collectively, by one or more processors of a device to cause the device to:
identify, from among a plurality of snapshot files of a computing object stored at a data management system (DMS), that a first snapshot file representing a first state of the computing object at a first point-in-time is expired, wherein the first snapshot file is partitioned into a first set of data portions stored at a first set of storage locations at the DMS, and wherein a second snapshot file representing a second state of the computing object at a second point-in-time is partitioned into a second set of data portions stored at a second set of storage locations at the DMS; and
generate, based at least in part on identifying that the first snapshot file is expired, from the first snapshot file and the second snapshot file, a third snapshot file representing the second state of the computing object at the second point-in-time, wherein:
the third snapshot file is partitioned into a third set of data portions, one or more first data portions of the third set of data portions being stored at one or more storage locations within the first set of storage locations and one or more second data portions of the third set of data portions being stored at one or more storage locations within the second set of storage locations.

20. The non-transitory, computer-readable medium of claim 19, wherein the instructions are further executable, individually or collectively, by the one or more processors to cause the device to:
generate, prior to the first snapshot file being expired, the plurality of snapshot files for the computing object, the plurality of snapshot files comprising at least one full snapshot file and a plurality of incremental snapshot files, wherein the plurality of incremental snapshot files comprises the first snapshot file and the second snapshot file.
